(19) United States
(12) Patent Application Publication
(10) Pub. No.: US 2013/0041053 A1
(43) Pub. Date: Feb. 14, 2013

(54) Process for the Preparation of Polyesters with High Recycle Content

(71) Applicants: Thomas Joseph Pecorini, Kingsport, TN (US); Eric Jon Moskala, Kingsport, TN (US); David Lange, Blountville, TN (US); Robert William Seymour, Kingsport, TN (US)

(72) Inventors: Thomas Joseph Pecorini, Kingsport, TN (US); Eric Jon Moskala, Kingsport, TN (US); David Lange, Blountville, TN (US); Robert William Seymour, Kingsport, TN (US)

(73) Assignee: EASTMAN CHEMICAL COMPANY, Kingsport, TN (US)

(21) Appl. No.: 13/208,590

(22) Filed: Aug. 12, 2011

(51) Int. Cl. C08J 11/04

(52) U.S. Cl. 521/48

(57) ABSTRACT

Disclosed is a process for producing copolyesters with high levels of recycled content. Scrap or post-consumer poly(ethylene terephthalate) is depolymerized by methanolysis or glycolysis to produce a purified, recycled dimethyl terephthalate which can be repolymerized with 2 or more diols. The polyesters of this invention have physical properties and an appearance that is similar to polyesters prepared from virgin monomers. In addition to dimethyl terephthalate, the polyesters can be prepared from recycled ethylene glycol recovered from depolymerization of poly(ethylene terephthalate) and/or 1,4-cyclo-hexanedimethanol prepared by hydrogenation of recycled dimethyl terephthalate or recovered from depolymerized polyester mixtures.

### BACKGROUND OF THE INVENTION

The increased use of plastics over the past several decades, especially for packaging, has led to substantial efforts to recycle the plastic articles. Recycling provides a more sustainable option than land filling or incineration and considerable infrastructure is in place in many countries to collect used plastic containers and process them into a form where the plastic can be used again to make useful articles. This infrastructure is widely available for poly(ethylene terephthalate), abbreviated herein as “PET,” which is the most widely used polyester. Fibers, sheeting, containers and a variety of molded articles, therefore, are being produced from recycled PET or a mixture of recycled and virgin material. Products incorporating a high recycle content are valued by both brand owners and consumers.

Copolyesters prepared from monomers such as, for example, dimethyl terephthalate, terephthalic acid, isophthalic acid, 1,4-cyclohexanedicarboxylic acid, ethylene glycol, 1,4-cyclohexanedimethanol, and 2,2,4,4-tetramethyl-1,3-cyclobutanediol, are widely used in applications such as handled containers, cosmetic bottles, sheeting, reusable bottles for water and sports drinks, and appliance parts. For these applications, high clarity is a requirement.

One method that has been used to provide copolyesters with high recycle content is simply to blend recycled PET with a copolyester. This approach has been used, for example, to prepare blends of virgin poly(butylene terephthalate) (“PBT”) with recycled PET to yield a PBT-based product with recycle content (see, for example, U.S. Patent Application Publication No. 2009/0275698). Blends of other copolyesters with PET, however, are generally immiscible and produce a polymer blend that is opaque. This is not a concern for PBT applications because PBT itself is inherently opaque. For copolyester applications, however, opacity is not acceptable. Blending with recycled PET, therefore, is not a satisfactory method to provide copolyesters with recycle content. Hence, a method to provide copolyester products having a high recycle content with properties that are equivalent to copolyesters prepared from virgin materials remains an ongoing need. There is also a need to recycle PET products that cannot be utilized in traditional mechanical recycling processes because of various deficiencies such as, for example, low molecular weight, contamination, presence of additives, low crystallinity, and the like. The ability to recycle PET products that cannot be satisfactorily processed by mechanical means and incorporate the recycled monomers into new copolyesters would provide significant benefits to the industry.

### DETAILED DESCRIPTION OF THE INVENTION

This invention pertains to the preparation of copolyesters having a high level of recycle content. More particularly, this invention pertains to a process for the preparation of copolyesters having a high level of recycled monomer content by depolymerizing a scrap or post-consumer, terephthalate-containing polyester with an alcohol or glycol, recovering a recycled dimethyl terephthalate and ethylene glycol, and using one or more of the recycled monomers to prepare a copolyester containing a high mole percentage of recycled monomer residues. In a general embodiment, therefore, the present invention provides a process for the preparation of a copolyester having a high recycled content, comprising:
(i). depolymerizing a polyester comprising the residues of terephthalic acid and ethylene glycol under depolymerization conditions of temperature and pressure to produce a depolymerized polyester mixture comprising ethylene glycol and monomeric terephthalate diesters;
(ii). recovering a recycled dimethyl terephthalate and, optionally, a recycled ethylene glycol from the depolymerized polyester mixture;
(iii). polymerizing the recycled dimethyl terephthalate with two or more glycols to produce a copolyester with recycled content.
   Depolymerization of post-consumer polyester into its monomeric components offers advantages over other recycling methods because some of the recovered monomers can be obtained in high purity by conventional techniques such as distillation, crystallization and filtration. The pure recycled monomers subsequently can be used in a copolyester production process. Copolyesters having a high recycle content, therefore, may be prepared that are similar to the same copolyesters prepared from virgin monomers, provided that the recycled monomers are prepared with sufficient purity.

In some embodiments, our invention produces recycled monomers from polyester waste materials that are not currently recovered by simple blending methods because compositional incompatibilities, the presence of contaminants, polymer additives, low molecular weight, crystallinity, and other problems. Our process utilitizes depolymerization methods that, typically, can accept a broad array of polyester waste sources to produce recycled monomer feedstocks for repolymerization into copolyesters. For example, many current recycling PET technologies are limited to polyester waste that contains minimal contamination and polymer additives, has a sufficiently high molecular weight, and has a high degree of crystallinity. Because of the versatility of polyester depolymerization processes, these difficult polyester waste streams can be recycled to give base monomers that can be repolymerized into new copolyesters containing, for example, dimethyl terephthalate, 1,4-cyclohexanedimethanol, 1,4-cyclohexanedicarboxylic acid, 2,2,4,4-tetramethyl-1,3-cyclobutanediol, dimethyl isophthalate, and/or ethylene glycol.

There are known depolymerization techniques for scrap or waste terephthalate polyesters, i.e., PET. These methods include alcoholysis and glycolysis and, typically, produce mixtures of terephthalate diesters, ethylene glycol, polyester oligomers, and other monomers, depending on the make-up of polyester scrap. The monomeric and/or oligomeric components can be purified and subsequently repolymerized to produce a copolyester having a high level of recycled content. Although, these processes are typically used for the depolymerization and recycling of poly(ethylene terephthalate), it will be apparent to persons of ordinary skill in the art that these same techniques are applicable to the recycling other polyester materials. For example, one known technique is to subject the polyester, typically PET, to methanolysis in which the polyester is reacted with methanol to produce a depolymerized polyester mixture comprising polyester oligomers, dimethyl terephthalate (“DMT”), and ethylene glycol (“EG”). Other monomers such as, for example, 1,4-cyclohexanedimethanol (“CHDM”), diethylene glycol, dimethyl isophthalate also may be present, depending on the composition of the polyester. Some representative examples of the methanolysis of PET are described in U.S. Pat. Nos. 3,321,510; 3,776,945; 5,051,528; 5,298,530; 5,414,022; 5,432,203; 5,576,456; 6,262,294; and others. A representative methanolysis process can be illustrated with particular reference to the disclosure of U.S. Pat. No. 5,298,530, which describes a process for the recovery of ethylene glycol and dimethyl terephthalate from scrap polyester. The process includes the steps of dissolving scrap polyester in oligomers of ethylene glycol and terephthalic acid or dimethyl terephthalate and passing super-heated methanol through this mixture. The oligomers can comprise any low molecular weight polyester polymer of the same composition as that of the scrap material being employed as the starting component such that the scrap polymer will dissolve in the low molecular weight oligomer. The dimethyl terephthalate and the ethylene glycol are recovered from the methanol vapor stream that issues from depolymerization reactor.

In the above process, scrap PET is conveyed through a loading system to a dissolver containing terephthalate oligomers. The loading system can be any conventional system known to persons skilled in the art such as, for example, screw feeders, extruders, or batch adders. The dissolver is equipped with agitator and jacket with internal heating coils. At startup, oligomers of a glycol such as ethylene glycol and dimethylterephthalate oligomers are introduced into dissolver that is heated to a temperature of about 145° C. to about 305° C. For example, the temperature range can be about 230° C. to about 290° C. The scrap PET and the oligomers are agitated in the dissolver for a time sufficient to allow the scrap polyethylene terephthalate to mix with the oligomers and form a startup melt. Typically, the time needed for mixing is about 5 minutes to about 60 minutes.

The startup melt is drawn through strainer and transferred by pump to a depolymerization reactor. Alternatively, all or a portion of the startup melt can be returned to the dissolver, which is useful during startup, as well as after startup should it be desired, to provide molten polyester to the top of the dissolver to initiate melting of fresh polyester scrap feed.

Super-heated methanol vapor is then passed through the contents of the depolymerization reactor, heating the reactor contents to form a melt comprising low molecular weight polyester oligomers, monohydric alcohol-ended oligomers, glycols, and dimethylterephthalate. Known, conventional systems can be used to heat and supply the methanol to the reactor and to recover the methanol for reuse such as, for example, the methanol supply and recovery loop described in U.S. Pat. No. 5,051,528.

A portion of the reactor melt can then be transferred from the reactor and passed to the dissolver where the reactor melt reacts and equilibrates with the molten scrap polyester chains to shorten the average chain length of the dissolver contents and thereby greatly decrease the viscosity. Accordingly, the oligomers that are initially introduced into the dissolver are typically needed just at startup. After startup, the process of the invention can be run continuously without having to further introduce external polyester chain-shortening material to the dissolver. The dissolver can be run at atmospheric pressure with little methanol present, greatly decreasing the risk of methanol leakage and increasing process safety. Simple solids handling devices such as rotary air locks can be employed since more elaborate sealing devices are not necessary. The viscosity of the melt transferred from the dissolver is sufficiently low to permit the use of inexpensive pumping means, and enables the reactor to be operated at pressures significantly higher than atmospheric pressure.

The depolymerization reactor can be run at a higher pressure than the dissolver, eliminating the need for pumping means to transfer the reactor melt from the reactor to the dissolver. Supplementary pumping means can optionally be provided if desired. The operating pressure of the depolymerization reactor can be about 6.9 kPa gauge (1 psig) to about 689.5 kPa gauge (100 psig). The reactor is typically operated at a pressure of about 206.8 kPa gauge (30 psig) to about 344.7 kPa gauge (50 psig). The temperature of the melt in the depolymerization reactor is maintained above the boiling point of methanol at the pressure present in the reactor in order to maintain the methanol in the vapor state and allow it to readily exit from the reactor. A typical melt temperature in the depolymerization reactor is about 180° C. to about 305° C. In another embodiment, for example, the melt temperature in the reactor can be about 250° C. to about 290° C. The return of reactor melt from the depolymerization reactor back to the dissolver may be adjusted to a rate that is selected based on the flow rates of material in and out of the dissolver and the desired ratio of molten reactor contents to molten scrap polyester in the dissolver. A typical ratio may be about 5 to about 90 weight percent reactor melt to scrap polyester. In another example, the ratio may be about 20 to about 50 weight percent reactor melt to scrap polyester. If desired, the recovery step (described below) can be omitted while reactor melt is transferred to the dissolver, for example, during standby operations when there is an interruption in the supply of scrap polyester to the dissolver, during plant startup, or while the melt in the dissolver is brought up to operating levels.

A vapor stream comprising dimethylterephthalate, ethylene glycol, and methanol exits the depolymerization reactor. Depending on the composition of the scap polyester, other monomers such as diethylene glycol, triethylene glycol, dimethyl-isophthalate, 1,4-cyclohexanedimethanol, and methylhydroxyethyl terephthalate also may be present in the methanol vapor stream. In addition to being a depolymerization reactant, the methanol vapor aids in removal of the other vapors from the reactor by acting as a carrier gas stream and by stripping the other gases from solution. The effectiveness of the super-heated methanol for heating the reactor contents and for stripping gases depends on its volumetric flow rate; the depolymerization rate in the reactor, therefore, depends on the methanol flow rate to the reactor. The methanol vapor stream exiting the depolymerization reactor optionally may be passed to a distillation device in order to separate methylhydroxyethyl terephthalate from the vapor stream. The recovered methylhydroxyethyl terephthalate may be passed to the dissolver where it is useful as a low molecular weight oligomer for shortening the average polyester chain length and decreasing the viscosity of the melt in the dissolver.

The vapor stream may then be transferred to a second distillation device which separates methanol from the other vapor stream components. The methanol can be recovered for further use as described in U.S. Pat. No. 5,051,528. The remaining recovered vapor stream components can be transferred other separation devices, e.g., distillation columns and crystallizers, where the DMT, ethylene glycol and, optionally, other monomers can be separated out.

The methanolysis process may be carried out as a semi-continuous or continuous process. After initial startup, the startup oligomers described above do not have to be provided from a source external to the process; that is, the melt provided from the depolymerization reactor and/or the methylhydroxyethyl terephthalate provided from optional distilling of the methanol vapor stream to the dissolver can shorten the average polyester chain length and sufficiently decrease the melt viscosity in the dissolver.

Most of the contaminants in the scrap or post-consumer PET are removed from the melt in the dissolver before introduction of the melt to the depolymerization reactor. For example, inorganic contaminants such as metals or sand are removed by straining the melt from the dissolver. Polyolefins and other contaminants, such as polyethylene, polystyrene and polypropylene, float on top of the melt in the dissolver and can be drawn off to a separator, removed, and the polyolefin-free melt is returned to the dissolver. Soluble contaminants can be allowed to accumulate in the melt in the dissolver and can be routinely purged with oligomers from the depolymerizatin reactor.

The dimethyl terepthalate (“DMT”) and ethylene glycol can be recovered and purified by conventional techniques known in the art such as, for example, by distillation, crystallization, or a combination of distillation and crystallization. Other monomers that may be present in the scrap polyester such as, for example, dimethyl isophthalate, 1,4-cyclohexanedimethanol, dimethyl 1,4-cyclohexanedicarboxylate, and diethylene glycol also can be recovered by conventional techniques noted above, and repolymerized into copolyesters. In one embodiment, for example, the methanol vapor stream exiting from the depolymerization reactor can comprise a gas phase stream comprising dimethyl terephthalate, ethylene glycol (“EG”), methanol and small amounts of impurities. The amount of impurities in the methanol vapor stream depends on the relative volatility of the impurities and DMT. If the volatility of the impurities is low enough, some of the impurities will be carried out of the reactor in substantial concentrations. Typically the methanol vapor stream is cooled and condensed to form a condensate comprising DMT dissolved in methanol. The temperature of this stream is then reduced and some of the methanol removed causing the dissolved DMT to precipitate as crystals. The solids are then separated by an appropriate separation method such as filtration or centrifugation. The crystals are then washed to remove most of the EG and other contaminants, which can be further separated and refined. The crude DMT is then distilled to obtain polymer grade material suitable for the preparation of copolyesters that are similar to the same copolyesters prepared from virgin materials. Other various methods of separating and purifying DMT and various glycol components from polyester depolymerization products have been described in U.S. Pat. Nos. 5,364,985; 5,391,263; 5,498,749; 5,712,410; and 7,078,440.

Glycolysis is another commonly used method of depolymerizing polyesters. A typical glycolysis process can be illustrated with particular reference to the glycolysis of PET, in which waste PET is dissolved in and reacted with a glycol, typically ethylene glycol, to form a mixture of dihydroxyethyl terephthalate and low molecular weight terephthalate oligomers. This mixture can be subjected to a transesterification reaction, usually in the presence of a ester exchange catalyst, with a lower alcohol, i.e., methanol to form dimethyl terephthalate and ethylene glycol, and other monomers, again depending upon the composition of the waste or scrap polyester feedstock. The DMT and ethylene glycol can be recovered and purified by distillation or a combination of crystallization and distillation. Some representative examples of glycolysis methods are disclosed in U.S. Pat. Nos. 3,257,335; 3,907,868; 6,706,843; and 7,462,649.

In a typical glycolysis procedure, PET waste and ethylene glycol are continuously fed to a glycolysis reactor operated at atmospheric pressure wherein the waste is dissolved and depolymerized. The depolymerization reaction is typically carried out at a temperature of 110 to 230° C. and a pressure (gauge pressure) of about 0.0 to 200 kPa. Higher temperatures may be used to increase the rate of depolymerization; however, reactor systems that can withstand elevated presssures may be required. A plurality of reactors may be used for the reaction of PET with ethylene glycol. For example, the reaction mixture can be continuously withdrawn from the first stage and introduced to a second stage maintained under pressure, along with additional ethylene glycol, wherein depolymerization continues. The quantities of ethylene glycol fed to the two stages are selected to degrade the polymer to dihydroxyethyl terephthalate and oligomers thereof without any substantial quantity of ethylene glycol remaining when degradation has reached the desired degree of completion.

The glycol-degraded depolymerization mixture from the glycolysis reactor(s), is then reacted with a monohydric alcohol under transesterification conditions of temperature and pressure. For example, the reaction temperature may be from 50 to 150° C. at a reaction pressure of 0.0 to 590 kPa gauge. In one embodiment, for example, the operating temperature is 190° to 230° C. In yet another embodiment, the glycolysis reaction mixture can be fed to an ester exchange column wherein the glycolysis mixture is contacted with an excess of monohydric alcohol, e.g., methanol, and an ester exchange catalyst at an elevated temperature and superatmospheric pressure to convert dihydroxyethyl terephthalate and oligomers present in the solution to a dialkyl terephthalate, e.g., DMT. The monohydric alcohol is selected in accordance with the desired dialkyl terephthalate; i.e., methanol is selected to prepare dimethyl terephthalate, a frequently used feedstock for making polyethylene terephthalate and the various copolyesters described herein. For simplicity, the process is hereinafter described with respect to methanol.

The ester exchange is a reversible reaction that requires a stoichiometric excess of methanol, elevated temperature, and an ester exchange catalyst to drive the reaction to acceptable yields of dimethyl terephthalate within a reasonable holding time. The weight ratio of methanol to glycolysis reaction mixture is generally at least 2 to 1, typically at least 3 to 1, and the temperature within the ester exchange column is generally maintained above 180° C. The temperature, however, will generally be less than about 300° C. since the vapor pressure of methanol at higher temperatures unduly complicates construction of the ester exchange column and supporting equipment.

Useful ester exchange catalysts are well known in the art and include, for example, the catalysts disclosed in U.S. Pat. No. 2,465,319. Representative catalysts include metal salts of acetic acid, such as zinc and manganese acetate, and organic amines, such as triethyl and tributylamine, carbonates, hydrogen carbonates and carboxylates of an alkali metal and an alkaline earth metals. For example, sodium carbonate may be used. Other catalysts which can be used will be apparent to those skilled in the art. The catalyst is generally prepared as a solution for ease in pumping to the pressurized ester exchange vessel.

A pressurized ester exchange vessel can be used to avoid loss of methanol vapors during the ester exchange reaction since removal of methanol will decrease the yield of dimethyl terephthalate. For example, the vessel can be operated at a pressure substantially the same as the partial vapor pressure of methanol at the temperature of the vessel.

Up to about 90 percent of the terephthalate values present in the glycol-degraded waste may be converted to dimethyl terephthalates at holding times of about 30 to 60 minutes. Other examples of reaction times are 30 minutes to 4 hours.

When the ester exchange reaction has reached the desired degree of conversion, an appropriate sequestering agent optionally may be added to the hot solution to deactivate the ester exchange catalyst. Addition of the sequestering agent may be accomplished while the solution is under superatmospheric pressure, i.e., the catalyst is deactivated before excess methanol is flashed from the solution. The sequestering agent, in solution, is can be added to the ester exchange vessel at a point where the sequestering agent does not prematurely deactivate the ester exchange catalyst, or may be added to a separate vessel provided for this purpose.

Useful catalyst sequestering agents are known in the art and include, but are not limited to, phosphoric acid; phosphorous acid; aryl, alkyl, cycloalkyl, and aralkyl phosphite phosphate esters; aliphatic and aromatic carboxylic acids such as oxalic acid, citric acid, tartaric acid and terephthalic acid, the tetradosodium salt of ethylene diamine tetraacetic acid; phenyl phosphinic acid; and the like. The amount of the selected sequestering agent used should be sufficient to effectively deactivate the catalyst since active catalyst will promote undesired ester exchange in the following operations and reduce the yield of dimethyl terephthalate.

The hot solution, after introduction of the sequestering agent, contains dimethyl terephthalate, small quantities of unreacted dihydroxyethyl terephthalate and oligomers, small quantities of hydroxyethyl methyl terephthalate mixed esters resulting from incomplete ester exchange, catalyst residues, inert material introduced with the waste, ethylene glycol, diethylene glycol, and excess methanol from the ester exchange reaction. Other monomers such as dimethyl isophthalate, 1,4-cyclohexanedimethanol, diethylene glycol, and dimethyl 1,4-cyclohexanedicarboxylate also may be present depending on the composition of the polyester waste. This hot solution is then processed for the removal of excess methanol. The methanol can be removed via flash distillation at a lower pressure, preferably atmospheric pressure, wherein substantially all of the methanol is flashed to the vapor state. Sufficient heat is added to the flash unit to maintain temperatures above the melting point of the solution but below the temperature at which significant reaction occurs between ethylene glycol and dimethyl terephthalate. Temperatures between 130° to 160° C. are typical for this purpose.

Alternatively, a two-stage process for the removal of methanol can be used. In the first stage, a hot solution containing deactivated ester exchange catalyst is further heated in a partially filled vessel, without release of the superatmospheric pressure maintained during the ester exchange, to continuously evolve methanol vapors therefrom.

The hot liquid leaving the flash unit may contain flocculated solids. Small particulate additives present in the waste can be extremely difficult to remove from the glycol-degraded waste, but tend to be flocculated after the ester exchange and methanol flashing steps. Moreover, the ester exchange catalyst residues tend to separate at this point of the process. Flocculation occurs at a point in the process where the solution has a temperature and viscosity particularly suited for solids removal. Thus, the hot reaction solution, after removal of methanol, can be fed to an instream solids separator unit which removes and discharges solids from the process. Removal of solids at this point prevents the deposition of solids and plugging in subsequent process lines and equipment during the recovery of dimethyl terephthalate and other monomers from the solution.

The solution leaving the flasher unit is typically at about 130° to 160° C. and should not be allowed to cool below about 125° C. prior to or during the solids removal operation. Dimethyl terephthalate starts to crystallize at about 125° C. and will be separated with the flocculated solids if lower temperatures are employed. Generally, the solids removal operation is conducted at about 140° to 160° C. to minimize dimethyl terephthalate losses. A conventional centrifuge, filter, or settling equipment can be employed.

After removal of solids, the hot solution is processed for the recovery of dimethyl terephthalate by distillation, crystallization, sublimation, or a combination of these techniques. Optionally, the aliphatic components (ethylene glycol and diethylene glycol) are first distilled from the solution for recycle or purge from the process and then dimethyl terephthalate is recovered from the solution.

The recycled DMT and ethylene glycol may be used directly in polycondensation reactions to prepare polyesters and copolyesters that are similar to the same polyesters prepared from virgin materials. The inherent viscosity of the copolyesters prepared with recycled monomers can be about 0.5 dl/g to about 0.9 dl/g, as determined. For example, the clarity (as measured by % haze and transmittance), tensile strength, flexural modulus, and impact strength of the copolyesters with recycled content are similar or identical to copolyester prepared entirely from virgin materials.

In one embodiment of our process, the DMT can be hydrolyzed to prepare terephthalic acid or hydrogenated to CHDM using known procedures. Similarly, TPA prepared from recycled DMT can be hydrogenated to form 1,4-cyclohexanedicarboxylic acid (“1,4-CHDA”). The TPA, 1,4-CHDA, and CHDM may then be repolymerized into copolyesters that exhibit excellent clarity and other physical properties.

The copolyesters with recycled content comprise dicarboxylic acid monomer residues, diol monomer residues, and repeating units. Thus, the term “monomer residue”, as used herein, means a residue of a dicarboxylic acid, a diol, or a hydroxycarboxylic acid. A “repeating unit”, as used herein, means an organic structure having 2 monomer residues bonded through a carbonyloxy group. The copolyesters of the present invention contain substantially equal molar proportions of acid residues (100 mole %) and diol residues (100 mole %) which react in substantially equal proportions such that the total moles of repeating units is equal to 100 mole %. The mole percentages provided in the present disclosure, therefore, may be based on the total moles of acid residues, the total moles of diol residues, or the total moles of repeating units. For example, a copolyester containing 30 mole % of a monomer, which may be a dicarboxylic acid, a diol, or hydroxycarboxylic acid, based on the total repeating units, means that the copolyester contains 30 mole % monomer out of a total of 100 mole % repeating units. Thus, there are 30 moles of monomer residues among every 100 moles of repeating units. Similarly, a copolyester containing 30 mole % of a dicarboxylic acid monomer, based on the total acid residues, means the polyester contains 30 mole % dicarboxylic acid monomer out of a total of 100 mole % acid residues. Thus, in this latter case, there are 30 moles of dicarboxylic acid monomer residues among every 100 moles of acid residues.

The term “polyester”, as used herein, encompasses both “homopolyesters” and “copolyesters” and means a synthetic polymer prepared by the polycondensation of a diacid component, comprising one or more difunctional carboxylic acids, with a diol component, comprising one or more, difunctional hydroxyl compounds. The term “copolyester,” as used herein, is intended to mean a polyester formed from the polycondensation of at least 3 different monomers, e.g., a dicarboxylic acid with 2 or more diols or, in another example, a diol with 2 or more different dicarboxylic acids. Typically the difunctional carboxylic acid is a dicarboxylic acid and the difunctional hydroxyl compound is a dihydric alcohol such as, for example glycols and diols. Alternatively, the difunctional carboxylic acid may be a hydroxy carboxylic acid such as, for example, p-hydroxybenzoic acid, and the difunctional hydroxyl compound may be an aromatic nucleus bearing 2 hydroxy substituents such as, for example, hydroquinone. The term “residue”, as used herein, means any organic structure incorporated into the polymer through a polycondensation reaction involving the corresponding monomer. The dicarboxylic acid residue may be derived from a dicarboxylic acid monomer or its associated acid halides, esters, salts, anhydrides, or mixtures thereof. For example, for the copolyesters of the present invention, the diacid component is typically supplied as dimethyl terephthalate.

The recycled monomers can be repolymerized into copolyesters using typical polycondensation reaction conditions well-known to persons skilled in the art. They may be made by continuous, semi-continuous, and batch modes of operation and may utilize a variety of reactor types. Examples of suitable reactor types include, but are not limited to, stirred tank, continuous stirred tank, slurry, tubular, wiped-film, falling film, or extrusion reactors.

They may be made by continuous, semi-continuous, and batch modes of operation and may utilize a variety of reactor types. Examples of suitable reactor types include, but are not limited to, stirred tank, continuous stirred tank, slurry, tubular, wiped-film, falling film, or extrusion reactors. The term “continuous” as used herein means a process wherein reactants are introduced and products withdrawn simultaneously in an uninterrupted manner. The process is operated advantageously as a continuous process for economic reasons and to produce superior coloration of the polymer as the copolyester may deteriorate in appearance if allowed to reside in a reactor at an elevated temperature for too long a duration.

The copolyesters of the present invention are prepared by procedures known to persons skilled in the art. The reaction of the diol component and the dicarboxylic acid component may be carried out using conventional copolyester polymerization conditions. For example, when preparing the copolyester by means of an ester interchange reaction, i.e., from the ester form of the dicarboxylic acid components, the reaction process may comprise two steps. In the first step, the diol component, i.e., recycled ethylene glycol or 1,4-CHDM, and the dicarboxylic acid component, such as, for example, recycled dimethyl terephthalate, are reacted at elevated temperatures, typically, about 150° C. to about 250° C. for about 0.5 to about 8 hours at pressures ranging from about 0.0 kPa gauge to about 414 kPa gauge (60 pounds per square inch, “psig”). Preferably, the temperature for the ester interchange reaction ranges from about 180° C. to about 230° C. for about 1 to about 4 hours while the preferred pressure ranges from about 103 kPa gauge (15 psig) to about 276 kPa gauge (40 psig). Thereafter, the reaction product is heated under higher temperatures and under reduced pressure to form the copolyester with the elimination of diol, which is readily volatilized under these conditions and removed from the system. This second step, or polycondensation step, is continued under higher vacuum and a temperature which generally ranges from about 230° C. to about 350° C., preferably about 250° C. to about 310° C. and most preferably about 260° C. to about 290° C. for about 0.1 to about 6 hours, or preferably, for about 0.2 to about 2 hours, until a polymer having the desired degree of polymerization, as determined by inherent viscosity, is obtained. The polycondensation step may be conducted under reduced pressure which ranges from about 53 kPa (400 torr) to about 0.013 kPa (0.1 torr). Stirring or appropriate conditions are used in both stages to ensure adequate heat transfer and surface renewal of the reaction mixture. The reaction rates of both stages are increased by appropriate catalysts such as, for example, alkoxy titanium compounds, alkali metal hydroxides and alcoholates, salts of organic carboxylic acids, alkyl tin compounds, metal oxides, and the like. A three-stage manufacturing procedure, similar to that described in U.S. Pat. No. 5,290,631, may also be used, particularly when a mixed monomer feed of acids and esters is employed.

To ensure that the reaction of the diol component and dicarboxylic acid component by an ester interchange reaction is driven to completion, it is sometimes desirable to employ about 1.05 to about 2.5 moles of diol component to one mole dicarboxylic acid component. Persons of skill in the art will understand, however, that the ratio of diol component to dicarboxylic acid component is generally determined by the design of the reactor in which the reaction process occurs.

In the preparation of a copolyester by direct esterification, i.e., from the acid form of the dicarboxylic acid component, copolyesters are produced by reacting the dicarboxylic acid or a mixture of dicarboxylic acids with the diol component or a mixture of diol components. The reaction is conducted at a pressure of from about 7 kPa gauge (1 psig) to about 1379 kPa gauge (200 psig), preferably less than 689 kPa (100 psig) to produce a low molecular weight, linear or branched copolyester product having an average degree of polymerization of from about 1.4 to about 10. The temperatures employed during the direct esterification reaction typically range from about 180° C. to about 280° C., more preferably ranging from about 220° C. to about 270° C. This low molecular weight polymer may then be polymerized by a polycondensation reaction.

The copolyesters with recycled content may comprise only recycled monomers or a mixture of recycled and virgin monomers. For example, the copolyester can comprise at least 0.5 mole percent of recycled dimethyl terephthalate, based on the total moles of diacid residues. In another example, the proportion of the diacid and diol residues that are from recycled monomers can each range from about 0.5 to about 100 mole percent, based on a total of 100 mole percent diacid residues and 100 mole percent diol residues. In still another example, the copolyester with recycled content can comprise 10 to 100 mole percent of the residues of the purified dimethyl terephthalate, based on the total moles of diacid residues. In yet another example, the copolyester with recycled content can comprise at least 50 mole percent of the residues of the purified dimethyl terephthalate, based on the total moles of diacid residues.

The copolyesters of our process comprise a diacid component and a diol component. The diacid component, for example, may comprise at least 60 mole percent, based on the total moles of diacid component, of the residues of terephthalic acid. In addition to terephthalic acid, the diacid component may further comprise about 0 to 20 mole percent of one or more modifying dicarboxylic acids. Examples of modifying dicarboxylic acids include, but are not limited to, fumaric, succinic, adipic, glutaric, isophthalic acid, azelaic, sebacic, resorcinol diacetic, diglycolic, 4,4′-oxybis(benzoic), biphenyldicarboxylic, 4,4′-methylenedibenzoic, trans-4,4′-stilbene-dicarboxylic, and sulfoisophthalic acids.

The diol component may comprise about 10 to 100 mole percent, based on the total moles of the diol component, of 1,4-cyclohexanedimethanol (referred to as “CHDM” hereinafter). The CHDM may be used as a pure cis or trans isomer or as a mixture of cis and trans isomers. In addition to CHDM, the diol component may comprise from 0 to about 90 mole percent of one or more diols selected from the diol component can comprise 10 to 100 mole percent, based on the total moles of the diol component, of the residues of 1,4-cyclohexanedimethanol and 0 to about 90 mole percent of the residues of one or more diols selected from the group consisting of neopentyl glycol, diethylene glycol, ethylene glycol, and 2,2,4,4-tetramethylcyclobutanediol. In one embodiment, the ethylene glycol can comprise recycled ethylene glycol from the depolymerized polyester mixture and the 1,4-cyclohexanedimethanol can comprise a recycled 1,4-cyclohexanedimethanol prepared by hydrogenation of the recycled dimethyl terephthalate or recovered from the depolymerized polyester mixture.

The copolyester with recycled content, for example, may comprise about 40 to 100 mole percent, based on the total moles of the diacid component, of the residues of terephthalic acid, about 0 to about 60 mole percent of the residues isophthalic acid, and about 100 mole percent, based on the total moles of the diol component, of the residues of 1,4-cyclohexanedimethanol. In another example, the copolyester with recycled content may comprise 50 to 95 mole percent of the residues of terephthalic acid and 5 to 50 mole percent of the residues of isophthalic acid. The diol component may comprise any of the diol residues discussed herein. For example, the diol component may comprise 100 mole percent of the residues of CHDM. In yet another example, the copolyester with recycled content may comprise 100 mole percent of the residues of terephthalic acid.

Some additional examples of copolyesters with recycled content that may be prepared from recycled DMT, dimethyl isophthalate, ethylene glycol, CHDM, and 1,4-CHDA include copolyesters in which the diacid component comprises from about 60 to 100 mole percent of terephthalic acid and the diol component comprises mixtures of CHDM and EG in which the CHDM ranges from about 10 to about 90 mole percent and the EG ranges from about 90 to about 10 mole percent. In another example, the diacid component can comprise about 60 to 100 mole percent terephthalic acid and the diol component can comprise mixtures of CHDM and 2,2,4,4-tetramethylcyclobutanediol (“TMCD”) wherein the CHDM ranges from about 50 to about 90 mole percent and the TMCD ranges from about 10 to about 50 mole percent. In still another example, the diacid component can comprise mixtures of about 50 to about 95 mole percent terephthalic acid and about 5 to about 50 mole percent isophthalic acid and the diol component can comprise 100 mole percent of the residues of CHDM. In still another example, the polyester can contain a diacid component comprising about 40 to about 100 mole percent of the residues of 1,4-cyclohexanedicarboxylic acid and a diol component comprising one or more diols selected from CHDM, ethylene glycol, and poly(tetramethylene glycol). In one embodiment, one or more of the 1,4-CHDA, CHDM, and ethylene glycol may recovered from a depolymerized polyester mixture or prepared from recycled DMT by conventional methods such as, for example, hydrogenation and/or hydrolysis.

The copolyester with recycled content may contain the residues of other diols in addition to CHDM. For example, the copolyester may comprise 80 to 100 mole percent of the residues of terephthalic acid, about 50 to about 90 mole percent of the residues of 1,4-cyclohexanedimethanol, and about 10 to about 50 mole percent 1,3-cyclohexane-dimethanol. Some additional examples of copolyester compositions include, but are not limited to, (i) a diacid component comprising about 100 mole percent of the residues of terephthalic acid and a diol component comprising about 10 to about 40 mole percent of the residues of 1,4-cyclohexanedimethanol and about 60 to about 90 mole percent of the residues of ethylene glycol; (ii) a diacid component comprising 100 mole percent of the residues of terephthalic acid and a diol component comprising about 10 to about 99 mole percent of the residues of 1,4-cyclohexanedimethanol, 0 to about 90 mole percent of the residues of ethylene glycol, and about 1 to about 25 mole percent of the residues of diethylene glycol; (iii) a diacid component comprising 100 mole percent of the residues of terephthalic acid and a diol component comprising about 50 to about 90 mole percent of the residues of 1,4-cyclohexanedimethanol and about 10 to about 50 mole percent of the residues of ethylene glycol; (iv) a diacid component comprising about 65 mole percent of the residues of terephthalic acid and about 35 mole percent of the residues of isophthalic acid and a diol component comprising 100 mole percent of the residues of CHDM; (v) a diacid component comprising 100 mole percent terephthalic acid and a diol component comprising 31 mole percent 1,4-cyclohexanedimethanol and 69 mole percent ethylene glycol; and (vi) a diacid component comprising 100 mole percent terephthalic acid and a diol component comprising 77 mole percent 1,4-cyclohexanedimethanol and 23 mole percent TMCD. It should be understood that the present invention further includes copolyesters with recycled content that comprise the diacid and diol components disclosed above in any combination.

### EXAMPLES

The process of the invention is illustrated by the following prophetic examples.

### Prophetic Example 1

Recycled DMT is prepared by methanolysis of PET, followed by purification by distillation. Recycled CHDM is prepared by hydogenating a portion of the recycled DMT. A copolyester comprising of 100 mole percent, based on the total diacid residues, of the residues of terephthalic acid, 31 mole percent of the residues of CHDM and 69 mole percent of the residues EG is prepared in which 100 mole percent of the terephthalic acid residues are obtained from recycled DMT. The copolyester contains 62 weight % recycled material. When made from recycled DMT and CHDM produced from recycled DMT, the recycle content is 78 weight %. The product is similar to product made from virgin monomers.

### Prophetic Example 2

Recycled DMT is prepared by glycolysis of PET, followed by purification by crystallization and distillation. Recycled CHDM is prepared by hydogenating a portion of the recycled DMT. A copolyester comprising of 100 mole percent, based on the total diacid residues, of the residues of terephthalic acid, 77 mole percent of the residues of CHDM and 23 mole percent of the residues of 2,2,4,4-tetramethyl-1,3-cyclobutanedioldiol is prepared in which 100 mole percent of the terephthalic acid residues are obtained from recycled DMT. The copolyester contains 48 weight % recycled material. When made from recycled DMT and CHDM produced from recycled DMT, the recycle content is 88 weight %. The product are similar to product made from virgin monomers.

### Prophetic Example 3

Recycled DMT is prepared by glycolysis of PET, followed by purification by crystallization and distillation. Recycled CHDM is prepared by hydogenating a portion of the recycled DMT. A copolyester comprising of 65 mole percent, based on the total diacid residues, of the residues of terephthalic acid and 35 mole percent of the residues of isophthalic acid, and 100 mole percent of the residues of CHDM is prepared in which 100 mole percent of the terephthalic acid residues are obtained from recycled DMT and 100 mole percent of the CHDM residues are obtained from CHDM prepared from recycled DMT. The copolyester contains 83 weight % recycled content. When made from recycled DMT and CHDM produced from recycled DMT, the recycle content is 88 weight %. The product is indistinguishable from product made from virgin monomers.

We claim:

1. A process for the preparation of a copolyester having a recycled content comprising at least 50 mole percent of the residues of the recycled dimethyl terephthalate, based on the total moles of diacid residues, comprising the steps of:
(i). depolymerizing a polyester comprising the residues of terephthalic acid and ethylene glycol under depolymerization conditions of temperature and pressure to produce a depolymerized polyester mixture comprising ethylene glycol and monomeric terephthalate diesters;
(ii). recovering a recycled dimethyl terephthalate and, optionally, a recycled ethylene glycol from the depolymerized polyester mixture;
(iii). polymerizing the recycled dimethyl terephthalate with two or more diols to produce a copolyester with recycled content.

2. The process according to claim 1, wherein the depolymerization step (i) comprises methanolysis or glycolysis.

3. The process according to any one of claim 1 or 2, wherein the dimethyl terephthalate is purified by distillation, crystallization, or a combination thereof.

4. The process according to claim 1, wherein the copolyester with recycled content comprises a diacid component comprising at least 60 mole percent, based on the total moles of diacid component, of the residues of terephthalic acid; and the diol component comprising 10 to 100 mole percent, based on the total moles of the diol component, of the residues of 1,4-cyclohexanedimethanol and 0 to about 90 mole percent of the residues of one or more diols selected from the group consisting of neopentyl glycol, diethylene glycol, ethylene glycol, and 2,2,4,4-tetramethylcyclobutanediol.

5. The process according to claim 4, wherein the ethylene glycol comprises recycled ethylene glycol from the depolymerized polyester mixture and the 1,4-cyclohexanedimethanol comprises a recycled 1,4-cyclohexanedimethanol prepared by hydrogenation of the recycled dimethyl terephthalate or recovered from the depolymerized polyester mixture.

6. The process according to any one of claims 1-3, wherein the diacid component comprises 40 to 100 mole percent of the residues terephthalic acid and 0 to 60 mole percent of the residues of isophthalic acid; and the diol component comprises about 100 mole percent of the residues of 1,4-cyclohexanedimethanol.

7. The process according to any one of claims 4-6, wherein the diacid component comprises 50 to 95 mole percent terephthalic acid and 5 to 50 mole percent isophthalic acid.

8. The process according to any one of claims 4-5, wherein the diacid component comprises 80 to 100 mole percent of the residues of terephthalic acid and the diol component comprises 50 to 90 mole percent of the residues of 1,4-cyclohexanedimethanol and further comprises 10 to 50 mole percent of the residues of 1,3-cyclohexanedimethanol.

9. The process according to any one of claims 4-5, wherein the diacid component comprises 100 mole percent of the residues of terephthalic acid.

10. The process according to claim 9, wherein the diol component comprises 10 to 90 mole percent of the residues of 1,4-cyclohexanedimethanol and 10 to 90 mole percent of the residues of ethylene glycol.

11. The process according to claim 9, wherein the diol component comprises 50 to 90 mole percent of the residues of 1,4-cyclohexanedimethanol and 10 to 50 mole percent of the residues of 2,2,4,4-tetramethylcyclobutanediol.

12. The process according to claim 9, wherein the diol component comprises 10 to 40 mole percent of the residues of 1,4-cyclohexanedimethanol and 60 to 90 mole percent of the residues of ethylene glycol.

13. The process according to claim 9, wherein the diol component comprises 10 to 99 mole percent of the residues of 1,4-cyclohexanedimethanol, 0 to 90 mole percent of the residues of ethylene glycol, and 1 to 25 mole percent of the residues of diethylene glycol.

14. The process according to claim 9, wherein the diol component comprises 50 to 90 mole percent of the residues of 1,4-cyclohexanedimethanol and 10 to 50 mole percent of the residues of ethylene glycol.
